(19) United States
(12) Patent Application Publication
(10) Pub. No.: US 2007/0179823 A1
(43) Pub. Date: Aug. 2, 2007

(54) Observation modeling

(76) Inventors: Kumar Bhaskaran, Englewood Cliffs, NJ (US); Joachim H. Frank, Greenwich, CT (US); Eric D. Wayne, Raleigh, NC (US)

Correspondence Address: LAW OFFICE OF IDO TUCHMAN (RSW), 82-70 BEVERLY ROAD, KEW GARDENS, NY, 11415, US

(21) Appl. No.: 11/343,145

(22) Filed: Jan. 30, 2006

(51) Int. Cl. G06F 9/44

(52) U.S. Cl. 705/7

(57) ABSTRACT

A model editor is configured to generate an observation model of the activity based on a modeling language. The observation model includes a specification of one or more activity metrics to be monitored. A monitor is configured to receive a plurality of models and events, such that at least one event describes a change in the activity metrics to be monitored. The modeling language may be a graphical notation language.

### BACKGROUND OF THE INVENTION

The present invention relates generally to monitoring systems. More specifically, the invention relates to a method and system of monitoring activity that operates on a plurality of models, and may use a graphical modeling language.

Businesses need to have real-time, specific data about their own operations. They also need to respond to certain events as they occur in real-time. To address these needs, business monitoring systems evolved. Business monitoring systems are computer-based systems which monitor real-world systems pertaining to a given business. The larger a business is, the less able any one employee of the business is to be aware of the state of the business as a whole. Thus, computerization of the business monitoring process may be used because computers can process the massive amounts of data required to monitor even the largest business in real-time. Computers can determine when a situation exists which requires an action and can notify the appropriate human or technological actor.

A datum tracked by a business monitoring system is referred to as a business metric. One type of business metric is the tracking data of a single instance of a business process (for example, start and end of individual steps, duration since start, human actors involved, etc.). Another type of business metric is the amount of revenue from the sale of a product, or a category of products. The numeric amount of revenue received would be a business metric. Business metrics from multiple instances can be aggregated into business process statistics, sales statistics by product or by country, etc. which would be higher-level business metrics. For example, a business may wish to model the amount of revenue earned in an entire country in one day. This statistic would be computed by adding the revenues from each individual sale in that country on that day. The resulting sum would be another business metric. Such aggregation may be repeated at an arbitrary number of levels. At a high level, these aggregates are sometimes known as “key performance indicators”. Common key performance indicators, or KPI's, include revenue, cost, and average, minimum and/or maximum response time, as long as such high-level metrics are deemed significant indicators of a business's performance. Tracking trends of KPI's is crucial to the success of a business. Many businesses use business monitoring systems to implement a “scorecard”, a dynamic comparison of performance to desired targets for each KPI.

In addition to tracking real-time data, business monitoring systems can actively produce alerts about situations requiring action. In the process of monitoring the real-world system, the business monitoring system may become aware of situations which require a response. For example, consider the business process statistic of revenue earned per country, per day. Suppose that if at any time revenue per country per day drops below 70% of a four month sliding average for that country, the local representative for that country should be advised of the situation so they may investigate the cause. The business monitoring system could be configured to automatically advise the appropriate representative if the statistic ever dropped below this threshold. Such events requiring a response may range in severity, and in particular may include critical business situations requiring an immediate response. Other examples would be inventory levels dropping below a critical threshold, or failure rates in a production line rising significantly above average.

### BRIEF SUMMARY OF THE INVENTION

One exemplary aspect of the present invention is a method for monitoring activity over time. The method includes a providing operation that supplies a model editor for creating an observation model using a graphical modeling language. The observation model specifies at least one activity metric of the activity and at least one activity event that cause a change in the activity metric. A receiving operation is configured to receive the observation model at a monitoring application. Furthermore, the monitoring application is capable of receiving a plurality of models, each of which configures the monitoring application's behaviour to enable monitoring a particular business activity, phenomenon, or system. An instantiating operation instantiates the observation model at the monitoring application. A listening operation is then configured to detect the specified activity event.

Another exemplary aspect of the present invention is a system for monitoring activity over time. The system includes a model editor configured to generate an observation model of the activity based on a modeling language. In one configuration, the modeling language is a graphical notation language. The observation model includes a specification of one or more activity metrics to be monitored. A monitor is configured to receive a plurality of models and events, wherein at least one event describes a change in the activity metrics to be monitored.

Yet a further exemplary aspect of the invention is a computer program product embodied in a computer usable media. The computer program product includes computer usable program codes configured to provide a model editor for creating an observation model using a graphical modeling language, receive the observation model at a monitoring application, instantiate the observation model at the monitoring application, and listening for the at least one activity event.

### BRIEF DESCRIPTION OF THE SEVERAL VIEWS OF THE DRAWINGS

FIG. 1 shows an exemplary environment depicting an embodiment of the present invention.

FIG. 2 shows a flowchart of the operations of an embodiment of the present invention.

FIG. 3 demonstrates the relationship between the observation model, the monitor and the event source as contemplated by one embodiment of the invention.

FIG. 4 lists a variety of symbols and elements which may appear in a graphical representation of an observation model.

FIG. 5 graphically represents a sample observation model.

FIG. 6 shows an exemplary business monitoring scenario.

FIG. 7 demonstrates an observation model, shown in the graphical representation of FIG. 4, which would govern the behavior of the monitoring application in order to monitor the exemplary scenario described in FIG. 6.

FIG. 8 shows an exemplary computer embodying one configuration of the present invention.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

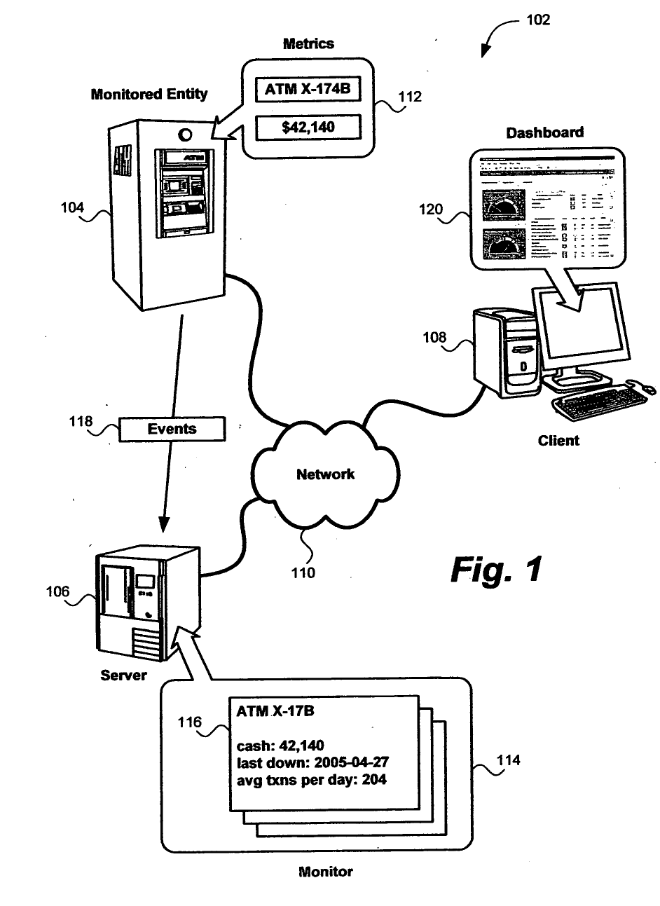

The following description details how the present invention is employed to monitor activity. Throughout the description of the invention reference is made to FIGS. 1-8. When referring to the figures, like structures and elements shown throughout are indicated with like reference numerals.

FIG. 1 shows an exemplary environment 102 depicting an embodiment of the present invention. The environment includes a monitored entity 104 (also referred herein as an event source). A server 106 monitors the activity of the monitored entity 104. A client 108 provides an interface to view the activity monitored by the server 106. The monitored entity 104, server 106 and client 108 communicate via a network 110. The network 110 may be any of various types known to those skilled in the art, such as TCP/IP, Wi-Fi or token ring.

It is emphasized that the exemplary environment 102 may include more than one monitored entity 104. In fact, it is contemplated that an arbitrary and possibly large number of monitored entities 104 will exist. This is so because the present invention is especially useful in monitoring complex environments which have too many entities to be monitored manually. Similarly, it is emphasized that more than one client 108 may exist within the exemplary environment 102. This may be the case if more than one person must be able to view activity of the monitored system, a case which is likely in a large organization.

The monitored entity 104 is any object in the real world whose state and events are to be monitored. In the exemplary environment 102, the monitored entity 104 is an automatic teller machine (ATM), a technological device permitting banking transactions including the withdrawal of funds in the form of cash. The monitored entity has one or more metrics 112. These metrics may include a unique identifier for the monitored entity, such as “X-174B”. They may also include measurable information about the state of the monitored entity. For example, the amount of money currently in the ATM is a metric 112; it is measurable and is known to be $42,140 at one moment in time. It is emphasized that the value of a metric may change over the course of time throughout the monitoring process. In fact, it is contemplated that the value will change over time, as one monitors those parameters which are likely to change to facilitate tracking and responding to the changes.

The server 106 is a technological device which monitors the activity of the monitored entity 104. In one embodiment of the present invention, the server 106 is a computer system which incorporates a computer program product implementing the present invention. In an alternative embodiment of the present invention, the server 106 is a specialized logic device designed specifically to process the models of the present invention. The server implements a monitoring application 114 (also referred to herein as a “monitor”) which tracks and represents the current state of the exemplary environment 102. The monitor 114 may include one or more monitoring contexts 116. A monitoring context 116 may also be referred to as a proxy object. Each monitoring context 116 is a virtual representation of a monitored entity 104. Thus, each monitoring context 116 may include one or more metrics of the underlying monitored entity 104.

The monitored entity 104 reports a change in its state to the server 106 by transmitting an event 118. The event 118 specifies sufficient information about the changes to the monitored entity 104 for the server 106 to update the corresponding monitoring context 116. The event may specify an updated value of a metric 112. However, it is contemplated that the effects of an event need not be limited to the simple update of a datum and may be complex. The event may include any data, instruction or information which conveys the changes in the state of the monitored entity 104 and allows updating the monitoring context 116 to reflect the changes. For example, to represent a withdrawal of $60 from the ATM, an event could specify either that the current amount of cash is $42,080 or that the amount of cash has decreased by $60. The server 106 includes functionality to receive events 118. It includes logic to associate each incoming event 118 with the appropriate monitoring context 116.

The client 108 is a technological device which offers an interface to the activity in the exemplary environment 102 as monitored by the server 106. In one embodiment of the present invention, the client 108 is a computer system implementing a computer program product known as a dashboard 120. The dashboard 120 implements a graphical interface enabling human users to graphically view the state of the monitored entity, as represented by the values of its metrics. In an alternate embodiment of the present invention, the client 108 is a specialized hardware device implementing the dashboard 120. In another embodiment of the present invention, the client 108 interfaces to other technological devices or computer program products to provide information about the exemplary environment 102 or to perform certain actions in response to changes of metric values of the monitored system.

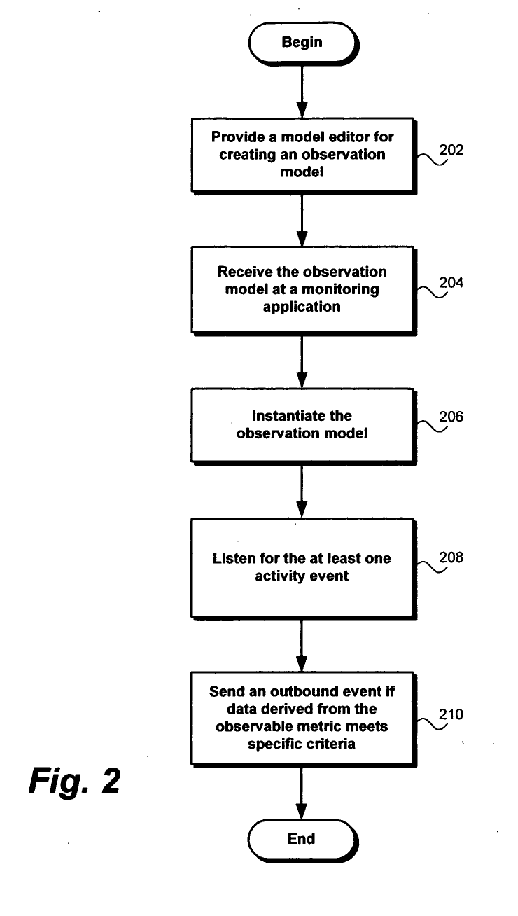

Turning now to FIG. 2, a flowchart of the operations of an embodiment of the present invention is shown. At providing operation 202, an embodiment of the present invention provides a model editor for creating an observation model. The observation model is a representation of the metrics of a real-world system which is to be monitored, and the events that this system emits to report state changes. The observation model may define one or more monitoring contexts 116. Typically, there is a separate monitoring context definition for each kind of monitored entity 104 within the real-world system; when an observation model is instantiated (step 206) the monitor typically creates an instance of the monitoring context definition (i.e., a “monitoring context”) for each instance of the monitored entity from which it receives real-time events. Each monitoring context 116 may contain one or more activity metrics 112, each of which represents an observed property of the monitored entity 104. The observation model may define one or more types of incoming events 118 and may specify how each impacts the state of the monitoring contexts that it defines. Such state changes may include changes to metrics but may also include more complex effects. The observation model may define one or more situations. Each situation is a set of criteria which, when met, results in specific behavior within the monitor, such as emitting a notification event as an alert of an occurrence of the situation. The observation model may additionally incorporate other types of elements. Some of these elements are discussed below, although it is emphasized that the possible types of elements are not limited to those discussed here. Finally, the observation model may define one or more maps, each of which defines a relationship between one or more input elements and one or more output elements. Examples of input elements are incoming events or metrics. Examples of output elements are metrics whose values depend on the current values of the input elements.

In an embodiment of the present invention, the model editor provides the ability to create and modify observation models using a graphical user interface (GUI). It is contemplated that this GUI may include functionality traditionally included in integrated development environments (IDE's), computer program products designed with the purpose of helping programmers develop other computer program products. This may include functionality to assist developers in detecting and removing errors in the model (“debugging”) and to allow developers to research technical details about building observation models (“online help”). Such functionality may reduce the time and cost required to develop observation models and may reduce the number of errors in the completed observation model.

In an alternate embodiment of the present invention, the observation model is specified using a textual language conforming to a syntax and grammar for specifying observation models. One form of such textual language may be Extensible Markup Language (XML). XML is a file format designed to allow specifying a wide range of types of data. XML files may be related to an XML schema, a file which defines syntax rules for a particular type of data. The embodiment may provide one or more XML schema files to specify the syntax of the XML files defining the observation model. It is contemplated that an external computer program product, designed for the general purpose of creating and modifying XML files, may utilize the XML schema files to allow users to create files which conform to the required syntax for an observation model. In any case, one skilled in the art can create an XML file using a computer program product designed to create and modify text files.

In another alternate embodiment of the present invention, the observation model may be specified using a combination of a GUI builder interface and a textual language. Both methods have their advantages, and providing both methods allows one skilled in the art to select the method most appropriate to the task. After providing operation 202 is completed, control passes to receiving operation 204.

At receiving operation 204, the observation model is received at a monitoring application 114. The monitoring application 114 interprets the observation model to determine its entities, relationships and other syntactical elements. The monitoring application 114 is able to perform this receiving operation for a plurality of observation models, subject to requirements of syntax and other specifications. Once receiving operation 204 is completed, control passes to instantiating operation 206.

At instantiating operation 206, the monitoring application 114 instantiates the observation model. In an embodiment of the present invention, the monitoring application creates an internal representation of the observation model. This representation may be created in random access memory or in other writeable storage media. The monitoring application 114 instantiates any monitoring context and any other entity defined by the observation model as existing in the initial state of the model, e.g., the state before any events have occurred. This proviso is necessary because an embodiment of the invention may permit monitoring contexts and other entities within the observation model to be created and destroyed throughout the life of the model. The representations of monitoring contexts and other entities may consist of data structures or similar techniques known to those skilled in the art. The monitoring application 114 may perform other initialization steps as required to prepare for execution of the observation model. After instantiating operation 206 is completed, control passes to listening operation 208.

At listening operation 208, the monitoring application 114 listens for one or more events 118 defined in the observation model. When an event 118 defined in the observation model is detected, the monitoring application 114 reacts to the event in a manner specified by the observation model. The elements and syntax discussed below allow a wide variety of possible responses to any particular event 118. However, it is also possible for an event 118 to be ignored completely by the monitoring application 114. This is possible and even desirable because only a subset of possible events may be of interest to the observation model. The monitoring application 114 may invoke an action within the instantiated observation model due to causes other than events. This may include user behavior. For example, if a user modifies a data entry field, the instantiated observation model may need to change accordingly. Moreover, entities internal to the model may spontaneously invoke an action. For example, timer elements (described below) may invoke an action at a given moment in time independently of any external events. However, it is contemplated that the monitoring application 114 generally operates under an event-driven paradigm.

At sending operation 210, the monitoring application 114 sends at least one type of outbound event. An observation model may define one or more possible outbound events. For each such outbound event, a set of criteria is defined. When these criteria are met, the outbound event is emitted. In one embodiment of the invention, these criteria are specified in the form of Boolean statements. The outbound event may be received by a wide variety of recipients. For example, it may be formatted as an alert message intended for a human being. Alternatively, the outbound event may be transmitted to another computer program product on the server 106 on which the monitoring application 114 is executing. It may be transmitted over a network 110 to a software or hardware device in an arbitrary location. The observation model also specifies how the data content of the outbound event is calculated based on current metric values (these specifications are modeled using maps).

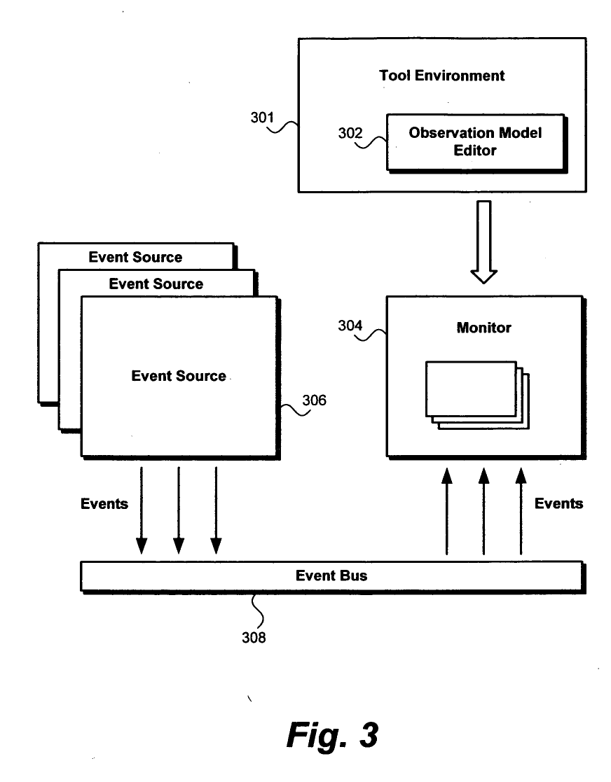

Turning now to FIG. 3, the relationship between the observation model, the monitor and the real-world system is demonstrated. A tool environment 301 includes a model editor 302 to create and edit the observation model. The tool environment 301 can be used by a software developer to create an observation model. The observation model created in this manner is received by the monitor 304, which instantiates the model as previously discussed.

In this example, an event source 306 is shown. An example for such an event source would be a workflow engine managing business processes, or an ATM as contemplated earlier. In response to real-world events which actually occur (for example, the beginning and end of steps in a business process or the successful completion of a cash transaction), the event source 306 generates electronic events. An electronic event encapsulates the relevant information about the real-world event which it represents. It is emphasized that while many of the examples discussed herein concern business monitoring and in particular business process monitoring, the real-world system need not be a business process engine or a business system. The real-world system may be any system which generates events describing observable phenomena or state changes and which a user of the present invention would like to monitor.

In an embodiment of the present invention, an event bus 308 connects the at least one event source 306 to the monitor 304. The event source 306 places the electronic event (which is referred to herein simply as an event) on the event bus 308. The monitor 304 receives the event and processes it as discussed in brief above and in detail below. In a further embodiment of the present invention, the event bus implements the Common Event Infrastructure. The Common Event Infrastructure is a standardized methodology of defining types of events and of receiving and transmitting specific instances of defined event types.

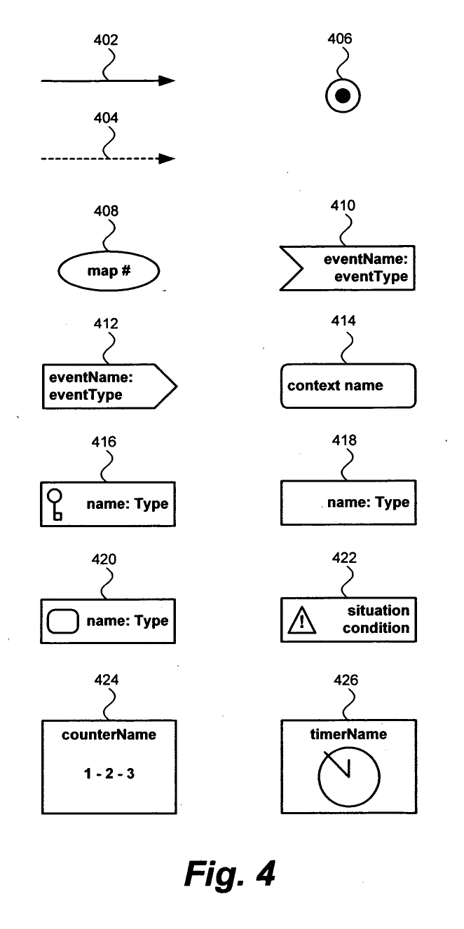

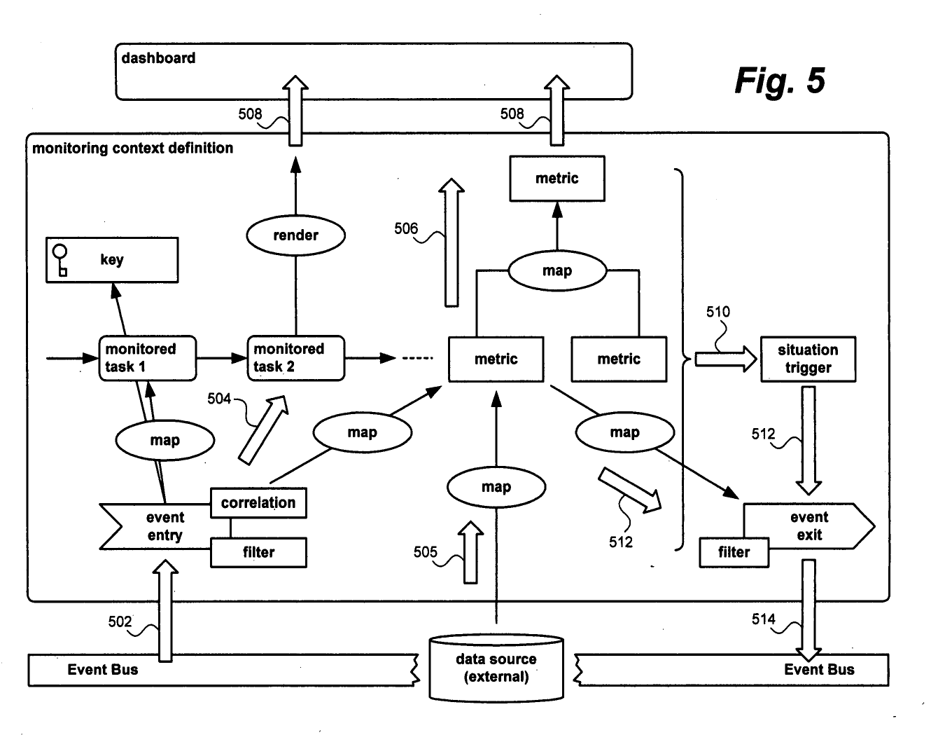

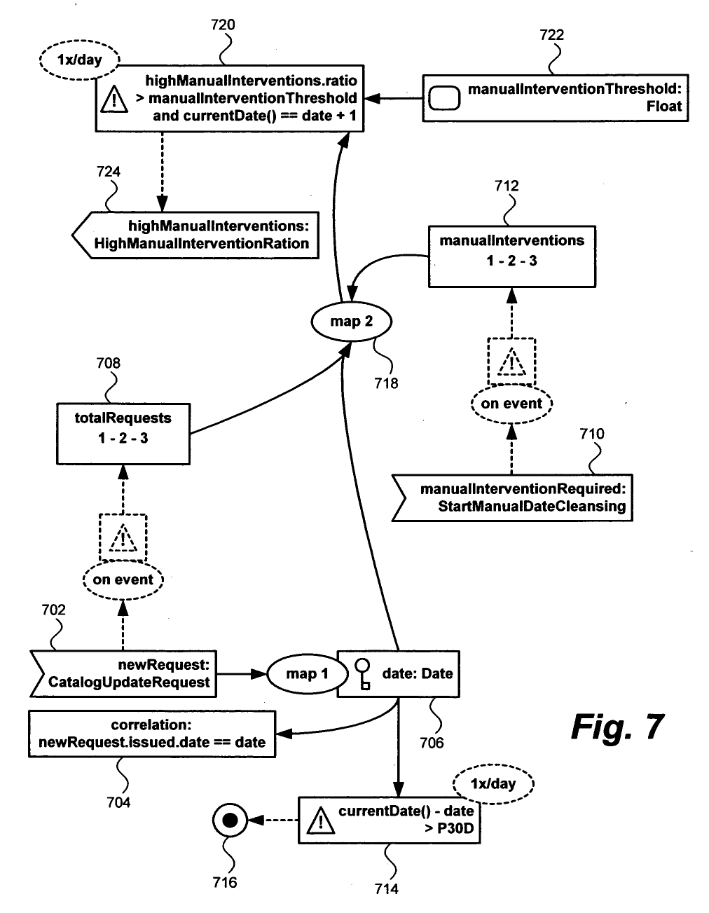

Turning now to FIG. 4, a variety of symbols and elements which may appear in a graphical representation of an observation model are listed. These symbols can help in understanding the graphical representation of an observation model shown in FIG. 5 and the behavior of the monitoring scenario shown in FIG. 7. Additionally, many of the symbols shown here are key element types of an observation model. Understanding these elements is itself helpful to understanding the possibilities enabled by an observation model.

A specific embodiment of the present invention may include either all the elements listed here or a subset thereof. It is emphasized that the types of elements which may be incorporated into an observation model are not limited to those detailed herein. Moreover, in an embodiment of the present invention, the user may add user-defined element types via an application programming interface (API), plug-in or other technological device allowing the functionality of a computer program product to be extended.

A solid arrow 402 indicates data flow.

A dotted arrow 404 indicates control flow. Note that in many cases, data and control flow along the same pathways at the same times. The reasons for and details of this behavior are clarified under the discussion of maps below.

A terminator 406 indicates the end of a data flow and/or a control flow.

A map 408 is used to connect elements within the observation model that represent data values (e.g., data slots, memory locations, etc.). A map has one or more input slots and one output slot. Each input slot connects to a metric 418 or to another type of entity in the observation model that carries a data value. The output slot likewise connects to a metric 418 or to another type of entity that can receive a data value. The map specifies some algorithm which receives the values in the input slots as input, performs a calculation on the received values and writes an output value to the output slot. The monitoring application 114 may ensure that if an input slot of a map changes for any reason, the map is recalculated and the output slot is updated. It is noted that the output slot of a map 408 may be the input slot of another map 408. In an embodiment of the present invention, the monitoring application 114 will recursively process any such cascading situations.

An event entry represents the point of entry of an inbound event into an instantiated observation model. This point of entry is defined by an inbound event definition 410, which specifies a specific type of inbound events to be received by the event entry. In an embodiment of the present invention, the event typology is defined using the Common Event Infrastructure. The event entry receives all inbound events of the type specified but ignores events not matching that type. Furthermore, the event entry may filter out events which, based upon specific criteria, are uninteresting to the instantiated observation model. As mentioned in the description of FIG. 1, the server 106 includes logic to associate each incoming event 118 with the appropriate monitoring context 116. Such associations are established using correlation criteria, which can be defined for inbound event definitions, and are evaluated by event entries at run time in order to correlate the remaining events with the appropriate monitoring context instance(s).

Similarly, an event exit 412 represents the point of exit of an outbound event from an instantiated observation model. This point of exit is defined by an outbound event definition, which specifies a specific type of outbound events to be emitted by the event exit 412. In an embodiment of the present invention, the event typology is defined using the Common Event Infrastructure. The event exit 412 emits outbound events of the specified type. Furthermore, the event exit 412 may filter out events which, based upon specific criteria, are uninteresting to the event consumer (another application reacting to events which, in fact, could again be another monitor).

A monitoring context definition 414 represents a type of monitored entity 104 within the real-world system. This concept is the same as the one discussed above and referred to as 116. However, additional detail is required in order to fully understand the monitoring context and its relationship to other entities in the diagram.

A monitoring context definition 414 in an observation model may exist zero, one or multiple times in the instantiated model at any given point in time. A key 416 allows multiple instances of a monitoring context 414 to be distinguished from each other. To illustrate, consider the ATM from the example in FIG. 1. In that example, the monitored ATM has a unique identifier, “X-174B”. Suppose another ATM, with a unique identifier of “X-253C”, is added to the bank's ATM network. The monitoring context definition 414 which represents an ATM is thus instantiated twice, once for each ATM. The key 416 distinguishes the two monitoring contexts 414: it contains “X-174B” in the first instance and “X-253C” in the second instance.

Each monitoring context definition 414 may include one or more metric definitions 418 (112 in the discussion above). Their instances would contain the corresponding metrics. It is noted that when a monitoring context 414 has multiple instances, the values of its metrics 418 may vary from instance to instance.

Finally, in an embodiment of the present invention, a monitoring context definition 414 may recursively contain one or more other monitoring context definitions 414. This typically corresponds to a real-world situation where a larger-scale monitored entity (such as an ATM network) contains many small-scale monitored entities (such as individual ATMs). The outer (containing) monitoring context definition typically contains the definitions of aggregate metrics (such as the total cash level of all ATMs in the network) while the inner monitoring context definitions contain metric definitions for the small-scale entities (such as the cash level of an individual ATM).

A data entry field definition 420 defines a value held in an instantiated monitoring context. This value may relate to other parts of the observation model in some manner. For example, suppose an action should be taken when an occurrence has been observed ten times. The value ten may be represented by a data entry field. The value of the data entry field may be modified during runtime by the user. In an embodiment of the present invention, when a data entry field is changed, the monitoring application 114 recursively processes any maps and other entities affected by the change to the data entry field.

A situation definition 422 defines a trigger for actions to occur when a set of criteria defined by the observation model are met. These criteria are known as the situation's “gating condition.” In an embodiment of the present invention, the gating condition is a logical expression which can be evaluated using Boolean algebra to one of two possible values: True or False. When the gating condition evaluates to True, within some monitoring context, the situation is said to “fire” within this context; the action specified by the situation definition 422 occurs. The action may impact other situations, maps or other entities in the observation model. In an embodiment of the present invention, when a situation fires, the monitoring application 114 recursively processes any situations, maps and other entities affected by situation's firing.

A counter definition 424 defines a value held in an instantiated monitoring context which may be incremented, decremented or reset. In an embodiment of the present invention, a map 408 and/or the firing of a situation 422 may impact a counter 424. It is contemplated that a counter 424 may be used in conjunction with a data entry field 420 to define thresholds at which an action should occur. An example of this possibility is demonstrated in FIG. 7. However, it is emphasized that each element offered as a feature of a given embodiment of the present invention is a tool developers may use in any fashion they choose. It is anticipated that developers will recombine the functionality provided for the observation model in countless ways.

A timer definition 426 defines a value in an instantiated monitoring context which represents elapsed time. The timer may be incremented proportionally to the amount of time which has passed in the real-time system. In an embodiment of the present invention, a timer may be reset. In another embodiment of the present invention, a timer may be stopped so that its value no longer changes with the passage of time, and may be subsequently restarted so as to continue to increment with the passage of time.

FIG. 5 graphically represents a sketch of a sample observation model, with the goal of explaining its semantics. While the graphical notation of observation models is used, the picture will be interpreted to represent an instantiated observation model, in order to explain its dynamic behavior within a monitor. Consequently, references to observation model elements, such as “event entry 410” or “timer 426”, should be read as “event entry, defined by an inbound event definition 410” or “timer, defined by a timer definition 426”. It is emphasized that the present invention is not limited to the kind of observation model displayed here. Rather, the model is meant to demonstrate the critical features and characteristic execution steps of a working observation model. More importantly, the exact behavior described herein applies only to one embodiment of the present invention. It is possible that other embodiments of the present invention may exhibit differing behavior when processing an observation model without departing from the scope and spirit of the present invention.

In step 502, an event entry, defined by an inbound event definition 410, receives inbound events 118. Each event entry is configured to receive events of a specific type as specified by the inbound event definition. In an embodiment of the present invention, the event typology is defined using the Common Event Infrastructure. Each event entry is configured to not receive (i.e. to ignore) events not matching the specified type. It is noted that an event of a given type may be received by more than one event entry.

The event entry 410 may apply one or more filtering conditions to the received event. A filtering condition is a condition which may or may not apply to a given event. In an embodiment of the present invention, the filtering condition is a logical expression which can be evaluated using Boolean algebra to one of two possible values: True or False. A received event only continues to be processed if any and all applicable filtering conditions evaluate to True for that event.

For any received events passing any filtering conditions, the event entry 410 applies correlation criteria to determine the monitoring contexts (instances) in which the event should be processed. Based on the correlation criteria, the event may be deliverable to zero, one or multiple monitoring context instances. In an embodiment of the present invention, the observation model may define separate behavior for each of these three cases. Such behavior may include: the creation of a new monitoring context instance (if no context was found to which the event was deliverable); raising an exception (if the number of target context instances is not as expected); or delivering the events to any or all of the monitoring context instances to which it was deliverable.

In step 504, the lower-level metrics throughout the observation model are populated. The lower-level metrics may be populated from incoming events. They may also be populated from data sources external to the observation model, as represented by arrow 505. Maps 408 may be invoked for the population of the lower-level metrics. In this case, the incoming event or external data source is the map's input slot and the lower-level metric is the map's output slot.

In step 506, higher-level metrics are calculated based on the lower-level metrics. This may be accomplished with maps 408, in which each lower-level metric is an input slot and the higher-level metric is the map's output slot. The higher-level metrics may constitute business process statistics and/or key performance indicators (KPI's), depending on the level of aggregation.

It is noted and anticipated that this process may be repeated recursively to produce progressively higher levels of aggregation of metrics. In this case, when a lower-level metric is updated, the maps are recursively processed to reflect the change in all higher levels of aggregation. Thus, changes even at a lower level have a cascading effect throughout the observation model.

In step 508, the dashboard 120 provides a graphical view of the observation model. The effects of the incoming event as it cascaded through the observation model are reflected in the dashboard 120. In one embodiment of the present invention, an interface is provided to allow specifying a subset of the observation model to be represented in the dashboard 120. It is anticipated that the dashboard may be used to view metrics at any level of aggregation and to view the state of other entities within the observation model.

In step 510, business situations are detected based on the changes to the metrics. In an embodiment of the present invention, the gating condition of a situation 422 is re-evaluated whenever a change in a metric or other datum could cause it to fire. In this embodiment, sophisticated algorithms determine which metrics or other data could, after any amount of recursive processing, impact the situation 422. The algorithm may elect to always re-evaluate the gating condition even when the value written to the metric or other datum is identical to the value previously residing there, because other changes, such as elapsed time, could cause a situation's gating condition to become true.

In step 512, outbound events are populated and triggered. It is noted that in this example, the outbound event is the end result of the cascading effects of the inbound event. It is further noted that this will not always be the case. The outbound event may be triggered by the firing of a situation 422. It may also be triggered by a map 408 or another type of entity within the observation model.

In step 514, an event exit 412 emits outbound events to an event bus. Each event exit 412 is configured to emit events of a specific type as specified by an outbound event definition. In an embodiment of the present invention, the event typology is defined using the Common Event Infrastructure.

The event exit 412 may apply one or more filtering conditions to the outbound event. A filtering condition is a condition which may or may not apply to a given event. In an embodiment of the present invention, the filtering condition is a logical expression which can be evaluated using Boolean algebra to one of two possible values: True or False. An outbound event is only emitted if any and all applicable filtering conditions evaluate to True for that event.

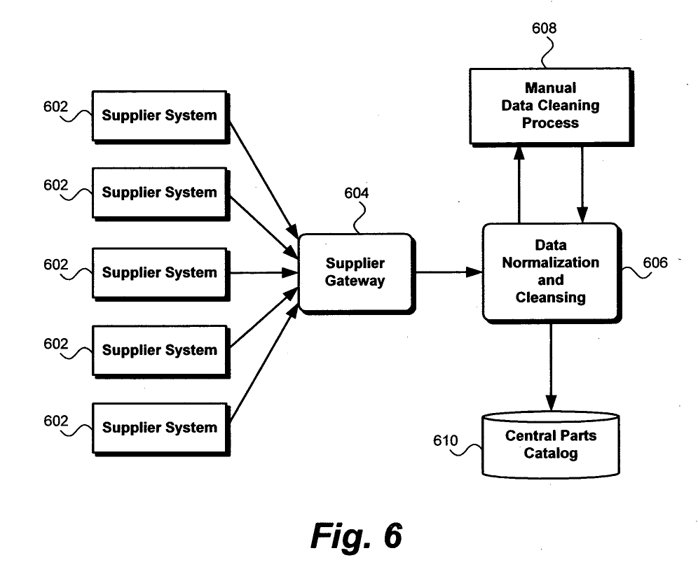

Turning now to FIG. 6, an exemplary business monitoring scenario is shown. In this environment, suppliers of parts interact via a centralized electronic marketplace. The computer systems of each supplier 602 send requests to update the central parts catalog to the marketplace's supplier gateway 604. The supplier gateway 604, upon receiving the request, emits an event. In step 606, the data in the update request is automatically normalized and confirmed to be valid and consistent. It is then automatically transformed into a standard format. If for any reason the data validation and normalization cannot be completed by the automatic process in 606, an exception is raised. An event corresponding to this exception is emitted. A manual data cleansing process 608 is invoked by this exception. In either case, the valid, standardized data is eventually incorporated into the central parts catalog 610.

A key performance indicator (KPI) is defined for this business scenario. This KPI is the manual intervention ratio. This KPI is to be calculated daily. The standard for acceptable performance is 5%. If the standard is exceeded numerically (note that this indicates violating the standard), a notification event is to be sent to the appropriate party.

Turning now to FIG. 7, a graphical representation of an observation model that would configure the behavior of the monitor in response to the exemplary scenario described in FIG. 6 is shown.

When an inbound event is emitted by the supplier gateway 604 in response to the catalog update request, the event is received at the event entry 702 for that event type. Next, correlating criteria 704 are applied to the event to determine to where it should be delivered. The date of the request is used as a key 706 to perform the correlation (there is one monitoring context instance for each day). The key 706 also indexes the instances of all other observation model elements shown in FIG. 7. An ensemble of these instances having the same key represents a monitoring context (instance). Each monitoring context includes counter 708 called “totalRequests”. If a totalRequests counter 708 already exists for the date of the request, the event is delivered to that counter. If no totalRequests counter 708 exists yet for that date, a new monitoring context is instantiated, indexed with the new date (using map 1), a counter for that date is created within the new context, and is initialized to zero. The event is then delivered to the new counter. In either case, the counter 708 to which the event is delivered is incremented by one. Thus, if the counter was just created, it now has a count of one.

Likewise, when an inbound event is emitted in step 606 in response to manual intervention being required, the event is received at the event entry 710 for that event type. This event is also correlated with the series of monitoring contexts, and a counter 712 called “manualInterventions” in the target context receives the event and is incremented. Here again, the date of the request is used as a key 706 both to perform the correlation and to index the monitoring context containing that day's “manualInterventions” counter. The correlation behaves similarly to that of the other event and counter, so it is not shown in the diagram.

The counters only need to be retained for 30 days in order to calculate the KPI's. Therefore, a situation 714 is evaluated once per day in each monitoring context. If it is over 30 days old, the situation 714 fires, resulting in the context (instance) and the counters within it being deleted 716.

A map 718 is used to calculate the manual intervention ratio for a given date. Its input slots point to the totalRequests counter 708 and manualInterventions counter 712 for that date. If totalRequests is zero for that date, the ratio is set to zero. Otherwise, the map divides manualInterventions by totalRequests to yield the ratio.

A situation 720, as its gating condition, compares the manual intervention ratio calculated by the map 718 to the manual intervention threshold. The threshold is defined as a data entry field 722. If the ratio exceeds the threshold, the situation 720 fires, causing an outbound event 724. The situation condition also compares the current date with the index of the monitoring context in which it is evaluated, to ensure that it can only fire within the context holding yesterday's counters. A situation reporting a high manual intervention ratio thus occurs on the day after the high ratio was observed (since manual intervention ratios are determined over 24 hour periods, this is the earliest point in time at which it can occur).

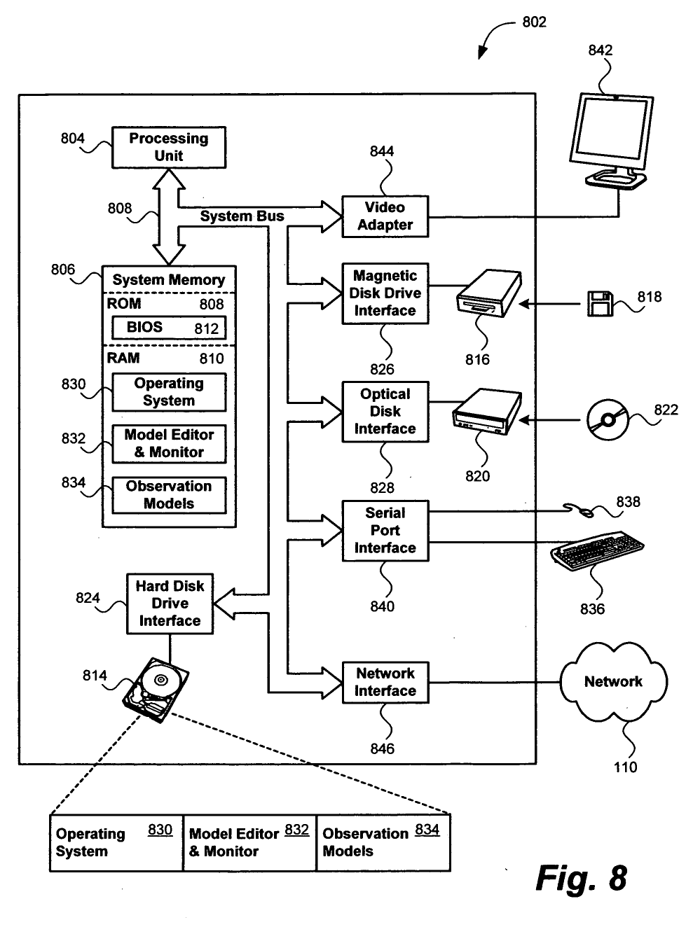

With reference to FIG. 8, an illustrative embodiment of the computer 802 in accordance with the present invention is shown. One computer 802 in which the present invention is potentially useful encompasses a general-purpose computer. Examples of such computers include SPARC(r) systems offered by Sun Microsystems, Inc. and Pentium(r) based computers available from International Business Machines Corp. and various other computer manufacturers. SPARC is a registered trademark of Sun Microsystems, Inc. and Pentium is a registered trademark of Intel Corporation.

The computer 802 includes a processing unit 804, a system memory 806, and a system bus 808 that couples the system memory 806 to the processing unit 804. The system memory 806 includes read only memory (ROM) 808 and random access memory (RAM) 810. A basic input/output system (BIOS) 812, containing the basic routines that help to transfer information between elements within the computer 802, such as during start-up, is stored in ROM 808.

The computer 802 further includes a hard disk drive 814, a magnetic disk drive 816 (to read from and write to a removable magnetic disk 818), and an optical disk drive 820 (for reading a CD-ROM disk 822 or to read from and write to other optical media). The hard disk drive 814, magnetic disk drive 816, and optical disk drive 820 are connected to the system bus 808 by a hard disk interface 824, a magnetic disk interface 826, and an optical disk interface 828, respectively. The drives and their associated computer-readable media provide nonvolatile storage for the computer 802. Although computer-readable media refers to a hard disk, removable magnetic media and removable optical media, it should be appreciated by those skilled in the art that other types of media that are readable by a computer, such as flash memory cards, may also be used in the illustrative computer 802.

A number of program modules may be stored in the drives and RAM 810, including an operating system 830, a model editor and activity monitor 832, one or more models 834, and other program modules and data (not shown). As discussed above, the computer 802 is configured to generate observation models and monitor. entity activity in accordance with these.

A user may enter commands and information into the computer 802 through a keyboard 836 and pointing device, such as a mouse 838. Other input devices (not shown) may include a microphone, modem, joystick, game pad, satellite dish, scanner, or the like. These and other input devices are often connected to the processing unit through a serial port interface 840 that is coupled to the system bus 808.

A display device 842 is also connected to the system bus 808 via an interface, such as a video adapter 844. In addition to the display device, the computer 802 may include other peripheral output devices (not shown), such as speakers and printers.

The computer 802 operates in a networked environment using logical connections to one or more remote devices. The remote device may be a server, a router, a peer device or other common network node. When used in a networking environment, the computer 802 is typically connected to the network 110 through a network interface 846. In a network environment, program modules depicted relative to the computer 802, or portions thereof, may be stored in one or more remote memory storage devices.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

That which is claimed is:

1. A method for monitoring activity over time, the method comprising:
providing a model editor for creating an observation model using a graphical modeling language, the observation model specifying at least one activity metric of the activity and at least one activity event causing a change in the at least one activity metric;
receiving the observation model; and
instantiating the observation model; and
listening for the at least one activity event.

2. The method of claim 1, further comprising sending a notification if data derived from the at least one activity metric and the at least one activity event meets criteria specified using the graphical modeling language.

3. The method of claim 1, further comprising generating at least one proxy object from the observation model.

4. The method of claim 1, further comprising aggregating the activity metrics into higher level metrics and key performance indicators.

5. A system for monitoring activity over time, the system comprising:
a model editor configured to generate an observation model of the activity based on a modeling language, the observation model comprising a specification of at least one activity metrics to be monitored; and
a monitor configured to receive a plurality of models and events, wherein at least one event describes a change in the at least one activity metrics to be monitored.

6. The system of claim 5, wherein the modeling language is a graphical notation language.

7. The system of claim 5, wherein the monitor comprises a user interface configured to visualize data derived from the at least one activity metrics.

8. The system of claim 5, wherein the monitor is configured to instantiate the observation model into at least one proxy object.

9. The system of claim 5, further comprising an event bus coupled to the monitor.

10. The system of claim 9, further comprising at least one event source coupled to the event bus and configured to generate various events, at least one of the events being monitored by the monitor.

11. The system of claim 5, wherein the model editor is further configured to define a set of criteria that generates a notification by the monitor if the criteria are met.

12. The system of claim 5, wherein the observation model firther comprises instructions for aggregating the activity metrics into higher-level metrics and key performance indicators.

13. A computer program product for monitoring activity over time, the computer program product comprising:
a computer usable medium having computer usable program code embodied herewith, the computer usable program code comprising:
computer usable program code configured to provide a model editor for creating an observation model using a graphical modeling language, the observation model specifying at least one activity metric of the activity and at least one activity event causing a change in the at least one activity metric;
computer usable program code configured to receive the observation model; and
computer usable program code configured to instantiate the observation model; and
computer usable program code configured to listen for the at least one activity event.

14. The computer program product of claim 13, further comprising computer usable program code configured to send a notification if data derived from the at least one activity metric and the at least one activity event meets criteria specified using the graphical modeling language.

15. The computer program product of claim 13, further comprising computer usable program code configured to generate at least one proxy object from the observation model.

16. The computer program product of claim 13, further comprising computer usable program code configured to aggregate the activity metrics into higher level metrics and key performance indicators.
